(19) United States
(12) Patent Application Publication
(10) Pub. No.: US 2019/0213872 A1
(43) Pub. Date: Jul. 11, 2019

(54) DEVICE AND METHOD FOR DETECTING THE SURROUNDINGS OF A MOTOR VEHICLE

(71) Applicant: Robert Bosch GmbH, Stuttgart (DE)

(72) Inventors: Albrecht Irion, Stuttgart (DE); Philipp Mayer, Ho Chi Minh City (VN); Rolf Nicodemus, Bietigheim-Bissingen (DE); Stefan Nordbruch, Kornwestheim (DE)

(21) Appl. No.: 16/330,969

(22) PCT Filed: Aug. 14, 2017
(86) PCT No.: PCT/EP2017/070613

§ 371 Date: Mar. 6, 2019

(30) Foreign Application Priority Data
Sep. 9, 2016 (DE) 10 2016 217 240.9

(51) Int. Cl. G08G 1/01; H04L 29/08; G08G 1/14

(52) U.S. Cl. CPC G08G 1/0112; B60R 16/0231; G08G 1/14; H04L 67/12

(57) ABSTRACT

A device for detecting motor vehicle surroundings, including: a parking control unit (PCU) (the PCU including a communication module), one or multiple sensor units, each including one or multiple surroundings sensors detecting the surroundings, and a communication interface for wired transmission of surroundings sensor data corresponding to the particular detection to the PCU, the communication module providing wired reception of the surroundings sensor data, the communication module transmitting the surroundings sensor data and/or surroundings data based on the surroundings sensor data to a data processing device via a wireless communication network so that the data processing device may transmit the surroundings sensor data and/or the surroundings data to a cloud server via a further wireless communication network. Also described is a motor vehicle, a method for detecting the motor vehicle surroundings, a method for processing a motor vehicle, a system for detecting the motor vehicle surroundings, and a computer program.

### FIELD OF THE INVENTION

The present invention relates to a device and a method for detecting the surroundings of a motor vehicle. Moreover, the present invention relates to a motor vehicle. The present invention relates to a method for processing a motor vehicle.

The present invention relates to a system for detecting the surroundings of a motor vehicle. Moreover, the present invention relates to a computer program.

### BACKGROUND INFORMATION

There are believed to be systems for ascertaining parking spaces on a roadside. They may include two subsystems: a first subsystem is situated in the motor vehicle and a second subsystem is situated in a cloud infrastructure.

The subsystem that is situated in the motor vehicle includes surroundings sensors that scan a roadside when the motor vehicle is traveling along the roadside. The raw sensor data are subsequently further processed in a parking control unit of the motor vehicle. This means, for example, that occupied or vacant spaces as well as their dimensions or distances from one another are ascertained in the parking control unit.

In a so-called “head unit”, the main control unit of the motor vehicle, or optionally in another computer, a position of the occupied or vacant spaces is additionally ascertained with the aid of a GPS sensor, for example.

These data (position of the ascertained space and its occupancy state, i.e., vacant or occupied) are sent via a communication unit of the motor vehicle to the subsystem situated in the cloud infrastructure.

The subsystem situated in the cloud infrastructure processes these data and determines, for example, whether or not a vacant space is an entry point. These further processed data are then, for example, transmitted back to the motor vehicle or to other motor vehicles, so that the information contained in these further processed data may be displayed in the particular motor vehicle and/or provided via the Internet.

Thus, an appropriately configured parking control unit must be situated in the motor vehicle. In particular, a position ascertainment component such as a GPS sensor must be situated within the motor vehicle. In particular, a communication component for communicating with the subsystem that is situated within the cloud infrastructure must be situated within the motor vehicle.

In addition, modifications to a vehicle-internal communication, for example to a bus system of the motor vehicle, are generally necessary.

For these reasons, subsequently installing the first subsystem, situated in the motor vehicle, in a completed motor vehicle, i.e., after its manufacture, is possible, if at all, only with significant modifications.

### SUMMARY OF THE INVENTION

An object underlying the present invention is to be seen as providing an efficient concept for efficiently detecting the surroundings of a motor vehicle, which overcomes the above-described disadvantages and efficiently allows a motor vehicle to become part of a system for ascertaining parking spaces also subsequently, i.e., after its manufacture.

This object may be achieved by the respective subject matter described herein. Advantageous embodiments of the present invention are the subject matter of the respective further descriptions herein.

According to one aspect, a device for detecting the surroundings of a motor vehicle is provided, including:
a parking control unit,
the parking control unit including a communication module,
one or multiple sensor units, each including one or multiple surroundings sensors for detecting the surroundings of a motor vehicle, and a communication interface for the wired transmission of surroundings sensor data corresponding to the particular detection to the parking control unit,
the communication module being configured for the wired reception of the surroundings sensor data,
the communication module being configured to transmit the surroundings sensor data and/or surroundings data based on the surroundings sensor data to a data processing device via a wireless communication network so that the data processing device may transmit the surroundings sensor data and/or the surroundings data to a cloud server via a further wireless communication network.

According to another aspect, a motor vehicle is provided that includes the device for detecting the surroundings of a motor vehicle.

According to another aspect, a method for detecting the surroundings of a motor vehicle, using the device for detecting the surroundings of a motor vehicle, is provided, including the following steps:
detecting the surroundings of a motor vehicle with the aid of the surroundings sensor(s),
transmitting by wire surroundings sensor data, corresponding to the detection, with the aid of the particular communication interface to the parking control unit,
receiving by wire the surroundings sensor data with the aid of the parking control unit, and
transmitting the surroundings sensor data and/or surroundings data based on the surroundings sensor data to a data processing device via a wireless communications network with the aid of the parking control unit, so that the data processing device may transmit the surroundings sensor data and/or the surroundings data to a cloud server via a further wireless communications network.

According to another aspect, a method for processing a motor vehicle is provided, the motor vehicle including one or multiple sensor units, each including a parking control unit and one or multiple surroundings sensors for detecting the surroundings of a motor vehicle, and a communication interface for the wired transmission of surroundings sensor data corresponding to the particular detection via a bus, in particular a CAN bus, of the motor vehicle, the parking control unit including a bus communication interface that is configured for wired reception of the surroundings sensor data via the bus, the parking control unit being free of a communication interface for transmitting the surroundings sensor data via a wireless communications network, the parking control unit being exchanged with another parking control unit that includes a communication module, the communication module being configured for wired reception of the surroundings sensor data via the bus, the communication module being configured for transmitting the surroundings sensor data and/or surroundings data based on the surroundings sensor data to a data processing device via a wireless communications network.

According to another aspect, a system for detecting the surroundings of a motor vehicle is provided, including:
the device for detecting the surroundings of a motor vehicle,
a cloud server that includes a communication interface that is configured for receiving the surroundings sensor data and/or the surroundings data via the further wireless communications network.

According to another aspect, a computer program is provided that includes program code for carrying out the method for detecting the surroundings of a motor vehicle when the computer program is executed on a computer.

The present invention is based on the finding that the above-mentioned object may be achieved by providing a parking control unit that receives by wire the surroundings sensor data from the surroundings sensors and/or from the sensor units, and transmits these surroundings sensor data and/or surroundings data based on these surroundings sensor data to a data processing device via a wireless communications network. As a result, the data processing device may then advantageously transmit these data to a cloud server via a further wireless communications network. This means that the surroundings sensor data and/or the surroundings data are transmitted wirelessly, not via a bus, to the data processing device. As a result, it is thus advantageously not necessary to make modifications to a motor vehicle bus.

As a result, a motor vehicle after manufacture may participate as a part of a system for ascertaining parking spaces, simply by exchanging the parking control unit.

In particular, due to the concept according to the present invention it is not necessary to make changes in or on the sensor units. Thus, the sensor units that are already installed in the motor vehicle within the scope of its manufacture may continue to be used.

In addition, due to the concept according to the present invention it is not necessary to make changes on and/or in a bus of the motor vehicle, provided that the data are wirelessly transmitted or sent from the parking control unit to the data processing device.

According to one specific embodiment, it is provided that the device includes the data processing device, the data processing device being configured for transmitting the surroundings sensor data and/or the surroundings data to the cloud server via the further wireless communications network.

According to another specific embodiment, it is provided that the data processing device is a mobile terminal, in particular a mobile telephone.

This yields, for example, the technical advantage that, for example, a mobile terminal, in particular a mobile telephone, of a driver of the motor vehicle may be efficiently utilized.

According to one specific embodiment, it is provided that the data processing device is a main control unit for a motor vehicle.

This yields, for example, the technical advantage that the main control unit may be efficiently utilized.

Within the meaning of the description, a main control unit may be referred to as a head unit, for example.

According to one specific embodiment, it is provided that the communication module includes a first communication interface, in particular a bus communication interface, for wired reception of the surroundings sensor data, and a second communication interface, in particular a WLAN or a Bluetooth communication interface, for transmitting the surroundings sensor data and/or the surroundings data to the data processing device.

This yields, for example, the technical advantage that the data may be efficiently transmitted, i.e., in particular transmitted and/or received.

This means, for example, that the wireless communications network is a WLAN communications network or a Bluetooth communications network, for example.

This means, for example, that the surroundings sensor data are transmitted from the sensor unit(s) to the communication module of the parking control unit via a bus communication system.

A bus communication system may also be referred to as a bus system. Within the meaning of this description, a bus includes a CAN bus and/or a FlexRay bus, for example.

This means in particular that the bus system includes a CAN bus and/or a FlexRay bus, for example.

According to another specific embodiment, it is provided that the further wireless communications network includes a mobile radio communications network and/or a WLAN communications network.

According to one specific embodiment, it is provided that the parking control unit and/or the data processing device are/is configured to ascertain, based on the surroundings sensor data, dimensions of a vacant space in the surroundings and/or dimensions of a space in the surroundings that is occupied by a motor vehicle, and to ascertain surroundings data corresponding to the ascertainment of the particular dimensions.

This yields in particular the technical advantage that the parking control unit and/or the data processing device may be efficiently utilized. This yields in particular the technical advantage that the cloud server may be relieved of this task.

According to one specific embodiment, it is provided that a position sensor for detecting a position of the motor vehicle is provided, the data processing device being configured for transmitting position data corresponding to the detection of the position to the cloud server via the further wireless communications network.

This yields in particular the technical advantage that the position of the detected surroundings may be efficiently ascertained, and may be efficiently provided to the cloud server remote from the motor vehicle.

According to one specific embodiment, it is provided that the position sensor is integrated into the data processing device or into the parking control unit.

In one specific embodiment, it is provided that in each case a position sensor is integrated into the data processing device or into the parking control unit.

According to one specific embodiment, it is provided that the sensor unit(s) is/are configured for encrypting the surroundings sensor data, the particular communication interface of the sensor unit(s) being configured for wired transmission of the encrypted surroundings sensor data to the parking control unit.

This yields in particular the technical advantage that the surroundings sensor data may be protected from unauthorized readout.

According to one specific embodiment, it is provided that the communication module is configured for wirelessly receiving the encrypted surroundings sensor data.

According to one specific embodiment, it is provided that the parking control unit is configured for decrypting the encrypted surroundings sensor data.

According to one specific embodiment, it is provided that the parking control unit is configured for encrypting unencrypted surroundings sensor data and/or unencrypted surroundings data.

According to one specific embodiment, it is provided that the communication module is configured for transmitting the encrypted surroundings sensor data and/or the encrypted surroundings data to the data processing device via the wireless communications network.

According to one specific embodiment, the sensor unit(s) include(s) a processor that is configured for encrypting the surroundings sensor data.

According to one specific embodiment, the surroundings sensor data are raw surroundings sensor data or include raw surroundings sensor data.

Within the meaning of the description, a surroundings sensor is, for example, one of the following surroundings sensors: a radar sensor, a LIDAR sensor, an ultrasonic sensor, a magnetic sensor, a laser sensor, a video sensor, in particular a video sensor of a video camera, or an infrared sensor.

For multiple surroundings sensors, these have identical or different designs, for example.

The term “respective” encompasses in particular the term “and/or.”

In one specific embodiment, it is provided that the parking control unit is configured for at least semiautonomously, in particular fully autonomously, parking and/or unparking a motor vehicle. Parking and/or unparking includes in particular parking in a vacant parking space and/or unparking from a parking space.

That the parking control unit is configured for at least semiautonomously, in particular fully autonomously, parking and/or unparking a motor vehicle means in particular that the parking control unit is configured for controlling transverse and/or longitudinal guiding of the motor vehicle.

In one specific embodiment, it is provided that the parking control unit is configured to ascertain, based on the surroundings sensor data, a distance of a motor vehicle from an object in the surroundings of the motor vehicle, for example during a parking and/or unparking operation of the motor vehicle. The parking control unit may be configured to output a warning based on the ascertained distance and/or to control a warning device to output a warning when the ascertained distance is less than or equal to a predefined threshold value. For example, the warning device includes an optical and/or haptic and/or acoustic signal generator. For example, the warning device includes a display device for displaying the warning.

As a result, this may yield, for example, the technical advantage that the driver of the motor vehicle may be efficiently warned so that a collision of the motor vehicle with the object may be avoided.

The warning device is, for example, included by the device for detecting the surroundings or by the motor vehicle.

In one specific embodiment, it is provided that the parking control unit is configured to measure a vacant parking space, based on the surroundings sensor data, in response to a user command, in particular prior to a parking operation of the motor vehicle.

The user command may come, for example, from the driver or another occupant of the motor vehicle. This means in particular that the parking control unit measures a vacant parking space upon request, based on the surroundings sensor data.

The parking control unit provides a result of this measurement, for example of a display device that displays the result.

A result includes in particular the statement concerning whether or not the motor vehicle fits in the vacant parking space.

According to one specific embodiment, it is provided that the method for detecting the surroundings of a motor vehicle is executed or carried out with the aid of the device for detecting the surroundings of a motor vehicle.

According to one specific embodiment, it is provided that the device for detecting the surroundings of a motor vehicle is configured or configured for executing or carrying out the method for detecting the surroundings of a motor vehicle.

Technical functionalities of the method for detecting the surroundings of a motor vehicle analogously result from corresponding technical functionalities of the device for detecting the surroundings of a motor vehicle, and vice versa.

According to one specific embodiment, it is provided that the motor vehicle is configured or configured for executing or carrying out the method for detecting the surroundings of a motor vehicle.

The parking control unit according to the method for detecting the surroundings of a motor vehicle is, for example, the parking control unit according to the device for detecting the surroundings of a motor vehicle.

According to one specific embodiment, the other parking control unit according to the method for processing a motor vehicle is, for example, the parking control unit according to the device for detecting the surroundings of a motor vehicle.

Technical functionalities of the system for detecting the surroundings of a motor vehicle analogously result from corresponding technical functionalities of the method and/or the device for detecting the surroundings of a motor vehicle, and vice versa.

According to one specific embodiment of the method for processing a motor vehicle, it is provided that a data processing device is installed in the motor vehicle. The data processing device is, for example, a mobile terminal, in particular a mobile telephone, or a main control unit.

Technical functionalities of the method for processing a motor vehicle analogously result from corresponding technical functionalities of the device for detecting the surroundings of a motor vehicle, and vice versa.

According to one specific embodiment of the method for processing a motor vehicle, it is provided that a data processing device is installed in the motor vehicle. The data processing device is, for example, a mobile terminal, in particular a mobile telephone, or a main control unit.

In one specific embodiment of the method for detecting the surroundings of a motor vehicle, the method includes the following steps:
wired reception of the surroundings sensor data with the aid of the parking control unit,
transmitting the surroundings sensor data and/or the surroundings data to the data processing device via the wireless communications network, with the aid of the parking control unit.

In another specific embodiment of the method for detecting the surroundings of a motor vehicle, it is provided that the data processing device transmits the received data (surroundings sensor data and/or surroundings data) to the cloud server via the further wireless communications network.

In one specific embodiment, the motor vehicle includes a bus.

Surroundings sensor data refer to data which originate directly from the surroundings sensors and which may include raw surroundings sensor data, for example.

Surroundings data refer to data that are computed or ascertained based on the surroundings data. Surroundings data include, for example, dimensions of an occupied or unoccupied space and/or an occupancy state of a space.

The parking control unit may ascertain appropriate surroundings data, for example based on the surroundings sensor data, and then transmit them to the data processing device. The data processing device transmits these received data, for example, directly to the cloud server and/or further processes these data itself and sends the further processed data to the cloud server. These further processed data may also be generally referred to as surroundings data, provided that they are based on the surroundings sensor data of the surroundings sensors. These further processed data may also be referred to below as further surroundings data.

In one specific embodiment, it is provided that the cloud server is configured to ascertain, based on the surroundings sensor data and/or on the surroundings data, dimensions of a vacant space in the surroundings and/or dimensions of a space in the surroundings that is occupied by a motor vehicle, and to ascertain surroundings data corresponding to the ascertainment of the particular dimensions.

The present invention is explained in greater detail below with reference to the exemplary embodiments.

### BRIEF DESCRIPTION OF THE DRAWINGS

FIG. 1 shows a device for detecting the surroundings of a motor vehicle.

FIG. 2 shows a flow chart of a method for detecting the surroundings of a motor vehicle.

FIG. 3 shows a flow chart of a method for processing a motor vehicle.

FIG. 4 shows a motor vehicle.

### DETAILED DESCRIPTION

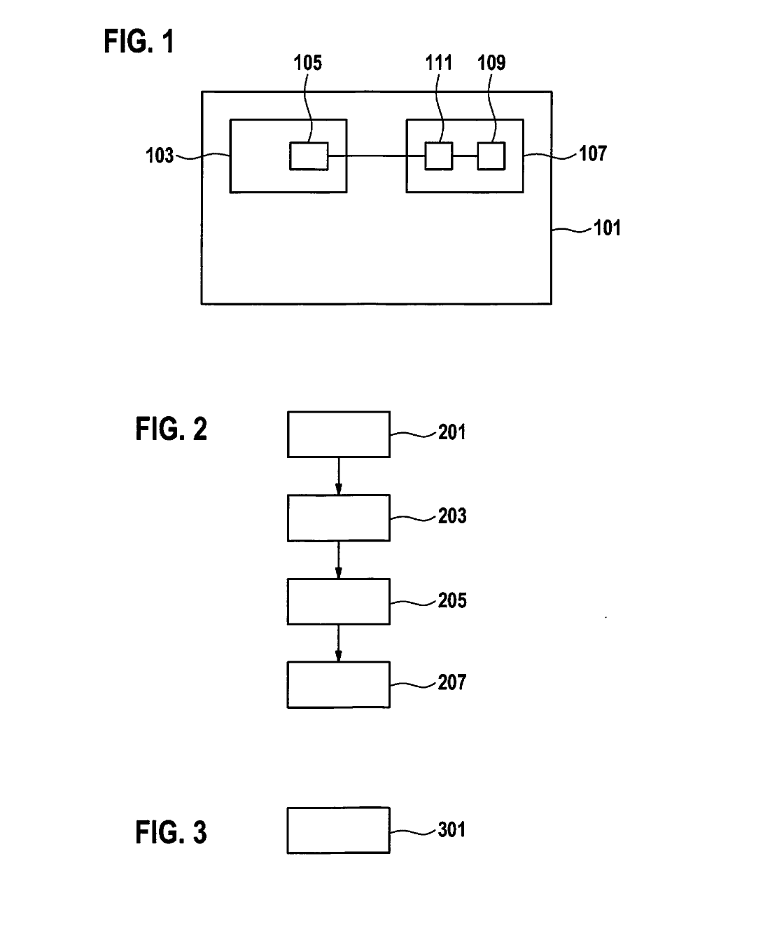

FIG. 1 shows a device 101 for detecting the surroundings of a motor vehicle. Device 101 includes:
a parking control unit 103,
parking control unit 103 including a communication module 105,
a sensor unit 107, in particular multiple sensor units, each including a surroundings sensor 109, for example multiple surroundings sensors, for detecting the surroundings of a motor vehicle, and a communication interface 111 for the wired transmission of surroundings sensor data corresponding to the particular detection to parking control unit 103,
the communication module 105 being configured for the wired reception of the surroundings sensor data,
the communication module 105 being configured to transmit the surroundings sensor data and/or surroundings data based on the surroundings sensor data to a data processing device via a wireless communication network so that the data processing device may transmit the surroundings sensor data and/or the surroundings data to a cloud server via a further wireless communication network.

In one specific embodiment, it is provided that parking control unit 103 is configured for at least semiautonomously, in particular fully autonomously, parking and/or unparking a motor vehicle.

According to one specific embodiment, device 101 includes the data processing device, which is configured for transmitting the surroundings sensor data and/or the surroundings data to the cloud server via the further wireless communications network.

According to one specific embodiment, a motor vehicle is provided that includes device 101.

In one specific embodiment, it is provided that the data processing device includes a position sensor for detecting a position of the motor vehicle. The position sensor is a GPS sensor, for example.

The parking control unit 103 includes a control device, for example, that is configured for controlling transverse and/or longitudinal guiding of the motor vehicle.

FIG. 2 shows a flow chart of a method for detecting the surroundings of a motor vehicle, using a device for detecting the surroundings of a motor vehicle, for example device 101 in FIG. 1.

The method includes the following steps:
detecting 201 the surroundings of a motor vehicle with the aid of the surroundings sensor(s),
transmitting 203 by wire surroundings sensor data, corresponding to the detection, with the aid of the communication interface to the parking control unit, receiving 205 by wire the surroundings sensor data with the aid of the parking control unit, and
transmitting 207 the surroundings sensor data and/or surroundings data based on the surroundings sensor data to a data processing device via a wireless communications network with the aid of the parking control unit, so that the data processing device may transmit the surroundings sensor data and/or the surroundings data to a cloud server via a further wireless communications network.

According to one specific embodiment, it is provided that the data processing device transmits the surroundings sensor data and/or the surroundings data to the cloud server via the further wireless communications network.

FIG. 3 shows a flow chart of a method for processing a motor vehicle, the motor vehicle including a parking control unit and one or multiple sensor units, each of which includes one or multiple surroundings sensors for detecting the surroundings of a motor vehicle, and a communication interface for wired transmission of surroundings sensor data corresponding to the particular detection via a bus, in particular a CAN bus, of the motor vehicle, the parking control unit including a bus communication interface for wired reception of the surroundings sensor data via the bus, the parking control unit being free of a communication interface for transmitting the surroundings sensor data via a wireless communications network, the parking control unit being exchanged with another parking control unit 301 that includes a communication module, the communication module being configured for wired reception of the surroundings sensor data via the bus, the communication module being configured for transmitting the surroundings sensor data and/or surroundings data based on the surroundings sensor data to a data processing device via a wireless communications network.

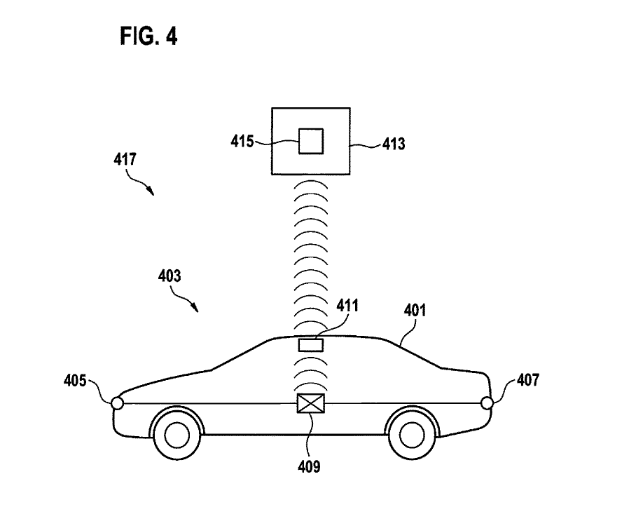

FIG. 4 shows a motor vehicle 401.

The motor vehicle 401 includes a device 403 for detecting the surroundings of a motor vehicle.

Device 403 includes two sensor units 405, 407, each of which includes one or multiple surroundings sensors for detecting the surroundings of motor vehicle 401, and a communication interface for the wired transmission of surroundings sensor data corresponding to the particular detection to a parking control unit 409.

For the sake of clarity, the communication interface and the surroundings sensors of the two sensor units 405, 407 are not shown.

Device 403 includes parking control unit 409, which is configured for at least semiautonomously, in particular fully autonomously, parking and/or unparking a motor vehicle, in the present case in particular motor vehicle 401.

Parking control unit 409 includes a communication module. The communication module is configured for the wired reception of the surroundings sensor data. The communication module is also configured to transmit the surroundings sensor data and/or surroundings data based on the surroundings sensor data to a data processing device 411 via a wireless communications network, so that data processing device 411 transmits and/or may transmit the surroundings sensor data and/or the surroundings data and/or further surroundings data based on the surroundings sensor data and/or based on the surroundings data to a cloud server 413 via a further wireless communications network.

For the sake of clarity, the communication module of parking control unit 409 is not shown.

The surroundings sensors of sensor units 405, 407 in each case detect the surroundings of motor vehicle 401, and transmit surroundings sensor data corresponding to this detection to parking control unit 409 with the aid of the particular communication interface. This transmission is carried out by wire, for example via a bus of the motor vehicle.

Parking control unit 409 ascertains, for example based on the surroundings sensor data, dimensions of a vacant space in the surroundings and/or dimensions of a space in the surroundings that is occupied by a motor vehicle, and ascertains surroundings data corresponding to the ascertainment of the particular dimensions.

Parking control unit 409 transmits these data to data processing device 411 via a wireless communications network. Data processing device 411 is included by device 403, for example. Data processing device 411 is included by motor vehicle 401, for example. Data processing device 411 is situated in particular within the motor vehicle.

Data processing device 411 is, for example, a mobile terminal, such as a mobile telephone of a driver or an occupant of motor vehicle 401.

Data processing device 411 is, for example, a main control unit of motor vehicle 401.

Data processing device 411 includes, for example, a first communication interface, such as a WLAN or a Bluetooth communication interface, for receiving the surroundings sensor data or the surroundings data from parking control unit 409 via the wireless communications network.

Data processing device 411 includes, for example, a second communication interface, such as a mobile radio communication interface, for transmitting the surroundings sensor data and/or the surroundings data and/or the further surroundings data to cloud server 413.

Cloud server 413 includes a communication interface 415 that is configured for receiving the surroundings sensor data and/or the surroundings data and/or the further surroundings data from data processing device 411 via the further wireless communications network.

Cloud server 413 is configured, for example, to ascertain, based on the received data, vacant and/or occupied parking spaces in the surroundings of motor vehicle 401 as well as their positions, for example their GPS positions.

These pieces of information, in particular the positions of the vacant or occupied parking areas or parking spaces, are transmitted, for example, to motor vehicle 401 via the further wireless communications network. These pieces of information are transmitted, for example, to other motor vehicles (not shown) via the further wireless communications network, so that they obtain information concerning where occupied and/or vacant, i.e., unoccupied, parking spaces or parking areas are situated.

Thus, FIG. 4 also shows a system 417 for detecting the surroundings of a motor vehicle.

System 417 includes device 403 and cloud server 413.

Providing a cloud server 413 has the technical advantage in particular that the cloud server may carry out efficient computations. In particular, the cloud server may efficiently receive a plurality of surroundings sensor data or surroundings data and/or further surroundings data from a plurality of motor vehicles, and correspondingly efficiently process same and transmit corresponding results of this processing and/or evaluation (the positions of the vacant and/or occupied parking spaces, for example) to the plurality of motor vehicles via the further wireless communications network.

According to one specific embodiment, it is provided that data processing device 411 is configured for displaying the information of cloud server 413 that is transmitted via the further wireless communications network.

Data processing device 411 includes, for example, a screen for displaying this information.

The present invention thus encompasses in particular the concept of exchanging one parking control unit of a motor vehicle with another parking control unit that may receive by wire the surroundings sensor data of the surroundings sensors, and may wirelessly transmit these surroundings sensor data and/or surroundings data based on these surroundings sensor data to a data processing device via a wireless communications network. This yields, for example, the technical advantage that, for example, no changes or modifications have to be made to a bus of a motor vehicle.

This means that the parking control unit that is now installed after the exchange in the motor vehicle has a new functionality: cable-free or wireless communication in addition to wired communication.

Within the meaning of the description, the terms “cable-free” and “wireless” may be used synonymously.

This means that the newly installed parking control unit includes a communication module that is configured for communicating wirelessly via a wireless communications network, in particular for wirelessly transmitting the surroundings sensor data and/or the surroundings data to a data processing device.

Thus, the surroundings sensor data, which may include raw surroundings sensor data, for example, and/or the surroundings data may be transmitted to the data processing device, which is a mobile terminal, for example.

For example, the surroundings sensor data are transmitted in encrypted form.

For example, a position sensor for detecting a position of the motor vehicle is provided, so that a position may be associated with the surroundings sensor data, and/or that a position may be associated with the surroundings data. This means that a position of the motor vehicle, i.e., appropriate position data, is/are linked to the surroundings data and/or the surroundings sensor data.

For example, the data processing device includes a position sensor, so that the data processing device may detect or determine a position of the motor vehicle at the point in time that the surroundings of the motor vehicle are detected.

According to one specific embodiment, the data processing device is configured to ascertain, based on the surroundings sensor data and/or based on the surroundings data, dimensions of a vacant space in the surroundings and/or dimensions of a space in the surroundings that is occupied by a motor vehicle, and to ascertain surroundings data, in the present case the further surroundings data, corresponding to the ascertainment of the particular dimensions. The dimensions together with the corresponding positions of the vacant spaces and/or the occupied spaces are then transmitted to the cloud server via the further wireless communications network, for example with the aid of the data processing device.

According to one specific embodiment, it is provided that in addition to or instead of the above-described ascertainment of the dimensions of the vacant spaces and/or the occupied spaces with the aid of the data processing device and/or with the aid of the parking control unit, the computations in question are carried out with the aid of the cloud server.

According to one specific embodiment, the cloud server is configured for computing further data, based on the received data (surroundings sensor data, surroundings data, or further surroundings data, for example), for example whether a vacant space is an entry point. For example, the cloud server ascertains whether a parking facility is completely full or whether there are still vacant parking spaces within a parking facility.

The data ascertained or computed by the cloud server may be transmitted to the data processing device and/or to other motor vehicles via the further wireless communications network, so that the data processing device, and/or the data processing devices of the other motor vehicles, may display these pieces of information.

According to one specific embodiment, it is provided that the data processing device is a “head unit”, i.e., a main control unit. According to this specific embodiment, it is provided that the main control unit includes a cable-free communication interface. This means that the cable-free communication interface may communicate wirelessly. For example, it is provided that the communication interface of the main control unit may communicate wirelessly via Bluetooth and/or WLAN.

This means that according to this specific embodiment, the data are transmitted wirelessly from the parking control unit to the main control unit, and from the main control unit are then transmitted wirelessly to the cloud server via the further wireless communications network.

It is usual for a motor vehicle to already have a main control unit that includes an infotainment system, for example. A main control unit that is already present in the motor vehicle generally already includes a communication module for wireless communication. In currently known motor vehicles, it is provided via such a communication module that the main control unit communicates with a mobile telephone of a vehicle occupant, for example to play music, stored on the mobile telephone, with the aid of the infotainment system.

Thus, it is no longer necessary to make modifications to the main control unit with regard to hardware. Rather, it is sufficient for such a main control unit to obtain a software update. This is generally done with little effort, and in addition there are no extra hardware costs.

The concept according to the present invention now has the advantage in particular that existing motor vehicles, i.e., motor vehicles that are already manufactured, may become part of a system for also subsequently ascertaining vacant or available parking spaces on a roadside. This is achieved according to the present invention with the aid of the device or by exchanging sensor units.

In particular, it is not necessary to make changes on or in the bus of the motor vehicle.

In particular, it is not necessary to install additional position detection components in the motor vehicle, provided that the data processing device already includes a position sensor.

In particular, it is not necessary to make changes to the main control unit except for the software update, provided that the communication is not to be carried out, for example, via the mobile telephone, but instead via the main control unit.

1-15. (canceled)

16. A device for detecting surroundings of a motor vehicle, comprising:
a parking control unit having a communication module;
one or multiple sensor units, each including one or multiple surroundings sensors for detecting the surroundings of the motor vehicle, and a communication interface for providing wired transmission of surroundings sensor data corresponding to a particular detection to the parking control unit;
wherein the communication module provides wired reception of the surroundings sensor data, and
wherein the communication module is for transmitting the surroundings sensor data and/or surroundings data based on the surroundings sensor data to a data processing device via a wireless communication network so that the data processing device can transmit the surroundings sensor data and/or the surroundings data to a cloud server via a further wireless communication network.

17. The device of claim 16, wherein the data processing device is for transmitting the surroundings sensor data and/or the surroundings data to the cloud server via the further wireless communications network.

18. The device of claim 16, wherein the data processing device includes a mobile terminal and/or a mobile telephone.

19. The device of claim 16, wherein the data processing device includes a main control unit for the motor vehicle.

20. The device of claim 16, wherein the communication module includes a first communication interface, which is a bus communication interface, for providing wired reception of the surroundings sensor data, and a second communication interface, including a WLAN or a Bluetooth communication interface, for transmitting the surroundings sensor data and/or the surroundings data to the data processing device.

21. The device of claim 16, wherein the parking control unit and/or the data processing device is for ascertaining, based on the surroundings sensor data, dimensions of a vacant space in the surroundings and/or dimensions of a space in the surroundings that is occupied by a motor vehicle, and to ascertain surroundings data corresponding to the ascertainment of the particular dimensions.

22. The device of claim 16, further comprising:
a position sensor to detect a position of the motor vehicle, wherein the data processing device is for transmitting position data corresponding to the detection of the position to the cloud server via the further wireless communications network.

23. The device of claim 22, wherein the position sensor is integrated into the data processing device or into the parking control unit.

24. The device of claim 16, wherein the sensor unit(s) is for encrypting the surroundings sensor data, and wherein the particular communication interface of the sensor unit(s) is for wired transmission of the encrypted surroundings sensor data to the parking control unit.

25. A motor vehicle, comprising:
a device for detecting surroundings of a motor vehicle, including:
a parking control unit having a communication module;
one or multiple sensor units, each including one or multiple surroundings sensors for detecting the surroundings of the motor vehicle, and a communication interface for providing wired transmission of surroundings sensor data corresponding to a particular detection to the parking control unit;
wherein the communication module is for providing wired reception of the surroundings sensor data, and
wherein the communication module is for transmitting the surroundings sensor data and/or surroundings data based on the surroundings sensor data to a data processing device via a wireless communication network so that the data processing device can transmit the surroundings sensor data and/or the surroundings data to a cloud server via a further wireless communication network.

26. A method for detecting, with a device, surroundings of a motor vehicle, the method comprising:
detecting, with the device, the surroundings of the motor vehicle with the aid of one or multiple surroundings sensor(s), wherein the device includes: a parking control unit having a communication module; one or multiple sensor units, each including the one or multiple surroundings sensors for detecting the surroundings of the motor vehicle, and a communication interface for providing wired transmission of surroundings sensor data corresponding to a particular detection to the parking control unit; wherein the communication module is for providing wired reception of the surroundings sensor data, and wherein the communication module is for transmitting the surroundings sensor data and/or surroundings data based on the surroundings sensor data to a data processing device via a wireless communication network so that the data processing device can transmit the surroundings sensor data and/or the surroundings data to a cloud server via a further wireless communication network;
transmitting by wire the surroundings sensor data, corresponding to the detection, with the aid of the particular communication interface to the parking control unit;
receiving by wire the surroundings sensor data with the aid of the parking control unit; and
transmitting the surroundings sensor data and/or surroundings data based on the surroundings sensor data to the data processing device via the wireless communications network with the aid of the parking control unit, so that the data processing device can transmit the surroundings sensor data and/or the surroundings data to a cloud server via the further wireless communications network.

27. A method for processing a motor vehicle, the method comprising:
exchanging a parking control unit with another parking control unit that includes a communication module, wherein the communication module is for providing wired reception of surroundings sensor data via a bus, and wherein the communication module is for transmitting the surroundings sensor data and/or surroundings data based on the surroundings sensor data to a data processing device via a wireless communications network;
wherein the motor vehicle includes the parking control unit and one or multiple sensor units, each of which includes one or multiple surroundings sensors for detecting the surroundings of a motor vehicle, and a communication interface for wired transmission of surroundings sensor data corresponding to the particular detection via a bus and/or a CAN bus, of the motor vehicle, the parking control unit including a bus communication interface for wired reception of the surroundings sensor data via the bus, the parking control unit being free of a communication interface for transmitting the surroundings sensor data via a wireless communications network.

28. A system for detecting surroundings of a motor vehicle, comprising:
a device for detecting surroundings of a motor vehicle, including:
a parking control unit having a communication module;
one or multiple sensor units, each including one or multiple surroundings sensors for detecting the surroundings of the motor vehicle, and a communication interface for providing wired transmission of surroundings sensor data corresponding to a particular detection to the parking control unit;
wherein the communication module is for providing wired reception of the surroundings sensor data, and
wherein the communication module is for transmitting the surroundings sensor data and/or surroundings data based on the surroundings sensor data to a data processing device via a wireless communication network so that the data processing device can transmit the surroundings sensor data and/or the surroundings data to a cloud server via a further wireless communication network; and
a cloud server that includes a communication interface for receiving the surroundings sensor data and/or the surroundings data via the further wireless communications network.

29. The system of claim 28, wherein the cloud server is for ascertaining, based on the surroundings sensor data and/or the surroundings data, dimensions of a vacant space in the surroundings and/or dimensions of a space in the surroundings that is occupied by a motor vehicle, and to ascertain surroundings data corresponding to the ascertainment of the particular dimensions.

30. A non-transitory computer readable medium having a computer program, which is executable by a processor, comprising:
a program code arrangement having program code for detecting, with a device, surroundings of a motor vehicle, by performing the following:
detecting, with the device, the surroundings of the motor vehicle with the aid of one or multiple surroundings sensor(s), wherein the device includes: a parking control unit having a communication module; one or multiple sensor units, each including the one or multiple surroundings sensors for detecting the surroundings of the motor vehicle, and a communication interface for providing wired transmission of surroundings sensor data corresponding to a particular detection to the parking control unit; wherein the communication module is for providing wired reception of the surroundings sensor data, and wherein the communication module is for transmitting the surroundings sensor data and/or surroundings data based on the surroundings sensor data to a data processing device via a wireless communication network so that the data processing device can transmit the surroundings sensor data and/or the surroundings data to a cloud server via a further wireless communication network;
transmitting by wire the surroundings sensor data, corresponding to the detection, with the aid of the particular communication interface to the parking control unit;
receiving by wire the surroundings sensor data with the aid of the parking control unit; and
transmitting the surroundings sensor data and/or surroundings data based on the surroundings sensor data to the data processing device via the wireless communications network with the aid of the parking control unit, so that the data processing device can transmit the surroundings sensor data and/or the surroundings data to a cloud server via the further wireless communications network.
